(19) United States
(12) Patent Application Publication
(10) Pub. No.: US 2010/0052266 A1
(43) Pub. Date: Mar. 4, 2010

(54) SEALING DEVICE

(75) Inventors: Masayuki Tanida, Fukushima (JP); Takehiro Nakagawa, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/532,042

(22) PCT Filed: Apr. 14, 2008
(86) PCT No.: PCT/JP2008/057233

§ 371 Date: Sep. 18, 2009

(30) Foreign Application Priority Data
May 11, 2007 (JP) 2007-126448
Mar. 18, 2008 (JP) 2008-069373

(51) Int. Cl. F16J 15/32

(52) U.S. Cl. 277/549

(57) ABSTRACT

To enhance lubricating oil supply function, a sealing device (1) between a shaft hole (42) and a shaft (43) includes a sealing device body (11) having a tubular fixed section (12) fixed in the shaft hole (42) and a seal lip (14) slidably contacted with the periphery of the shaft (43) and an oil supply member (31) having a tubular fitting section (32) fitted to the inner periphery of the fixed section (12) and a flange-shaped oil supply section (33) extending radially inward from the fitting section (32), the oil supply section (33) is arranged at the sealed fluid side from the tip of the seal lip (14), and projecting guide sections (37) for colleting oil attached to the oil supply section (33) and dropping it onto the shaft are provided at positions above the shaft (43) on an inner peripheral edge of the oil supply section (33).

### CROSS-REFERENCE TO RELATED APPLICATIONS

This is a national stage of the International Application No. PCT/JP2008/057233 filed on Apr. 14, 2008 and published in Japanese language.

### BACKGROUND OF THE INVENTION

1. Field of the Invention

The present invention relates to a sealing device, and more particularly to a sealing device structured such as to enhance a lubricating oil supply function to a seal lip sliding section. The sealing device in accordance with the present invention is used, for example, in an automotive relevant field, or is used in the other general purpose machine or the like.

2. Description of the Conventional Art

A sealing device 51 shown in FIG. 8 has been conventionally known. In this kind of sealing device 51, in order to reduce a heat deterioration and a sliding abrasion for improving a durability of a seal lip 52 made of a predetermined rubber-like elastic material, it is necessary to supply a lubricating oil to a seal lip sliding section 53. However, in the case that an oil to be sealed exists like a mist, the seal lip sliding section 53 tends to come to a poor lubricated state. Accordingly, there is a risk that a seal service life is lowered by the heat deterioration, the sliding abrasion or the like of the sliding section 53 (refer to Japanese Unexamined Patent Publication No. 2003-056718).

### SUMMARY OF THE INVENTION

### Problem to be Solved by the Invention

The present invention is made by taking the above points into consideration, and an object of the present invention is to provide a sealing device which can enhance a lubricating oil supply function to a seal lip sliding section, whereby it is made possible to improve a durability of a seal lip.

### Means for Solving the Problem

In order to achieve the object mentioned above, in accordance with a first aspect of the present invention, there is provided a sealing device installed to an inner periphery of a shaft hole of a housing and slidably coming into close contact with a peripheral surface of a shaft inserted to the shaft hole, the sealing device comprising:

a sealing device body integrally having a tubular fixed section fixed to the inner periphery of the shaft hole of the housing, and a seal lip slidably coming into close contact with the peripheral surface of the shaft; and

an oil supply member integrally having a tubular fitting section fitted to an inner peripheral side of the fixed section, and a flange-shaped oil supply section provided toward an inner side in a radial direction from the fitting section,

wherein the oil supply section is arranged at a sealed fluid side from a front end of the seal lip, and projecting guide sections for collecting an oil attached to the oil supply section so as to drop onto the shaft are provided at least at positions above the shaft on an inner peripheral edge section of the oil supply section.

Further, in accordance with a second aspect of the present invention, there is provided a sealing device as recited in the first aspect, wherein the oil supply member integrally has a tubular fitting section fitted to the inner peripheral side of the fixed section, a reverse section having a circular arc shaped cross section and integrally formed toward an inner side in a radial direction from one end section in an axial direction of the fitting section, an inner peripheral tube section integrally formed on the reverse section, and a flange-shaped oil supply section integrally formed toward the inner side in the radial direction from the other end section in the axial direction of the inner peripheral tube section, and projecting guide sections are provided on an inner peripheral edge section of the oil supply section.

In the sealing device in accordance with the present invention having the structure mentioned above, since the oil supply member is combined with the sealing device body, and the oil supply member collects the oil attached thereto so as to drop onto the shaft, it is possible to lubricate the seal lip slide section by the dropped oil.

Further, the sealing device body integrally has the tubular fixed section fixed to the inner periphery of the shaft hole of the housing, and the seal lip slidably coming into close contact with the peripheral surface of the shaft, and the oil supply member integrally has the tubular fitting section fitted to the inner peripheral side of the fixed section, and the flange-shaped oil supply section provided toward the inner side in the radial direction from the fitting section. Accordingly, since both the elements (the sealing device body and the oil supply member) are separately manufactured and are assembled with each other, the oil supply member can be assembled with the sealing device body in a later stage as occasion demands.

Further, the oil supply member has the flange-shaped oil supply section, the flange-shaped oil supply section is structured such as to attach the mist-like oil to the end face in the axial direction thereof, and collect it so as to drop as oil drops onto the shaft. Accordingly, since the oil supply section is formed in the flange shape and has a comparatively wide axial end face, it is possible to attach a lot of oil so as to drop.

Further, if the flange-shaped oil supply section is arranged above the seal lip, the oil is dropped onto the seal lip and is not dropped onto the shaft. As a result, there is fear that the oil is not supplied to the seal lip slide section. However, in the present invention, since the oil supply section is arranged at the sealed fluid side from the front end of the seal lip, it is possible to securely drop the oil onto the shaft.

Further, if the flange-shaped oil supply section remains in an annular shape, the attached oil flows in a circumferential direction through the annular axial end face and there is fear that the oil is not dropped onto the shaft. However, in the present invention, since the projecting guide sections for collecting the oil attached to the oil supply section so as to drop onto the shaft is provided at least at the positions above the shaft on the inner peripheral edge section of the oil supply section, it is possible to securely drop the oil onto the shaft from the guide sections.

Further, in the case that the oil supply member integrally has the tubular fitting section fitted to the inner peripheral side of the fixed section, the reverse section having the circular arc shaped cross section and integrally formed toward the inner side in the radial direction from one end section in the axial direction of the fitting section, the inner peripheral tube section integrally formed on the reverse section, and the flange-shaped oil supply section integrally formed toward the inner side in the radial direction from the other end section in the axial direction of the inner peripheral tube section, there is a possibility that the oil is attached to the inner peripheral surface of the fitting section, the inner surface of the reverse section and the outer peripheral surface of the inner peripheral tube section. Accordingly, an oil attached area is further enlarged.

Further, the oil supply member, which integrally has the tubular fitting section fitted to the inner peripheral side of the fixed section, the reverse section having the circular arc shaped cross section and integrally formed toward the inner side in the radial direction from one end section in the axial direction of the fitting section, the inner peripheral tube section integrally formed on the reverse section, and the flange-shaped oil supply section integrally formed toward the inner side in the radial direction from the other end section in the axial direction of the inner peripheral tube section as mentioned above, is fitted to the inner peripheral side of the fixed section from the reverse section having the circular arc shaped cross section at a time of being fitted to the sealing device body. Accordingly, since the reverse section has the circular arc shaped cross section, the reverse section has a chamfer section which can make the fitting easy in its outer surface, thereby having the chamfer section only by press work without any cutting work. Accordingly, it is possible to form the oil supply member having the chamfer section for making the fitting to the sealing device body easy only by the press work which does not accompany the cutting work.

### EFFECT OF THE INVENTION

The present invention achieved the following effects.

In the sealing device in accordance with the present invention, as mentioned above, since the oil supply member is assembled with the sealing device body, and the oil supply member collects the oil attached thereto so as to drop onto the shaft, it is possible to lubricate the seal lip slide section by the dropped oil. Further, since each of the sealing device body and the oil supply member is manufactured as the separate elements and is assembled with each other, it is possible to assemble the oil supply member with the sealing device body in a later stage as occasion demands. Further, since the oil supply member is formed in the flange shape and is structured such as to have the comparatively wide axial end face, it is possible to attach a lot of oil so as to drop down. Further, since the oil supply section is arranged at the sealed fluid side from the front end of the seal lip, it is possible to securely drop the oil onto the shaft. Further, since the projecting guide sections for collecting the oil attached to the oil supply section so as to drop onto the shaft are provided at least at the positions above the shaft on the inner peripheral edge section of the oil supply section, it is possible to securely drop the oil onto the shaft from the guide sections. Accordingly, it is made possible to enhance the lubricating oil supply function to the seal lip slide section, in accordance with the desired object of the present invention in cooperation of the above, whereby it is made possible to improve a durability of the seal lip.

Further, in the case that the oil supply member integrally has the tubular fitting section fitted to the inner peripheral side of the fixed section, the reverse section having the circular arc shaped cross section and integrally formed toward the inner side in the radial direction on one end section in the axial direction of the fitting section, the inner peripheral tube section integrally formed on the reverse section, and the flange-shaped oil supply section integrally formed toward the inner side in the radial direction on the other end section in the axial direction of the inner peripheral tube section, the oil attached area is further enlarged. Accordingly, it is made possible to supply a lot of oil to the lip slide section.

Further, in the case that the oil supply member integrally has the fitting section, the reverse section having the circular arc shaped cross section, the inner peripheral tube section and the flange-shaped oil supply section, it is made possible to form the oil supply member having the chamfer section for making the fitting to the sealing device body easy in accordance with only the press work which does not accompany the cutting work, and it is made possible to easy manufacture.

### BRIEF EXPLANATION OF DRAWINGS

FIG. 1 is a cross sectional view of a substantial part of a sealing device in accordance with a first embodiment of the present invention;

FIG. 2 is a side view of an oil supply member in the sealing device;

FIG. 3 is a side view of an oil supply member in according with a comparative example;

FIG. 4 is a side view showing a shape example of projecting guide sections;

FIG. 5 is a side view showing another shape example of the projecting guide sections;

FIG. 6 is a side elevational view showing another shape example of the projecting guide sections;

FIG. 7 is a cross sectional view of a substantial part of a sealing device in accordance with a second embodiment of the present invention; and

FIG. 8 is a cross sectional view of a substantial part of a sealing device in accordance with a conventional art.

### DETAILED DESCRIPTION OF PREFERRED EMBODIMENT

In this case, the following embodiments are included in the present invention.

(1) In the conventional oil seal, a service life is lowered by a heat deterioration and an abrasion of a sliding surface, with respect to a poor lubrication. To cope with this problem it is effective to give a lubrication by dropping oil attached to an oil side surface of an assembling ring (a protecting ring) to a shaft. Further, even if the assembling ring exists, the oil dripping off from an upper section drops along a circular arc in the case that an inner periphery of the assembling ring is formed in a circular shape. Accordingly, there is a case that sufficient dropping to the shaft can not be obtained, however, it is possible to dam the dropping oil so as to easily drop to the shaft, by setting an irregularity (a cut, a projection or the like) in the inner periphery.

(2) It is possible to reduce a chamfer work by providing a reverse section in an outer peripheral section of the assembling ring (the protecting ring). Further, since the reverse section is provided, a collecting and holding performance of the oil drip rises, and a greater oil drop is formed and is easily supplied to the shaft. Further, a mold releasing resistance from a press is reduced by forming the inner peripheral side of the reverse section in a taper shape, whereby it is made possible to easily recover the oil attached to the inner side as well as it is made possible to prevent a deformation at a time of releasing a product from the mold.

### Embodiment

Next, a description will be given of embodiments in accordance with the present invention with reference to the accompanying drawings.

### First Embodiment

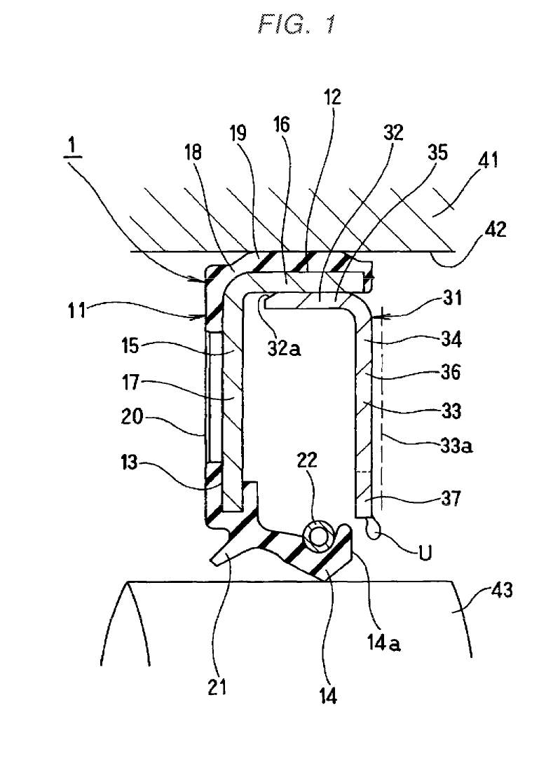

FIG. 1 shows a cross section of a substantial part of a sealing device (also called as an oil seal) 1 in accordance with a first embodiment of the present invention. The sealing device 1 in accordance with the embodiment is structured such as to be installed to an inner periphery of a shaft hole 42 of a housing 41 so as to slidably come into close contact with a peripheral surface of a shaft 43 inserted to the shaft hole 42, and is constructed by a combination of a sealing device body 11 and an oil supply member (also called as an assembling ring, an installing ring or a protecting ring) 31.

The sealing device body 11 has a tubular fixed section 12 fixed to an inner peripheral surface of the shaft hole 42 of the housing 41, flange-shaped lip holding section 13 is integrally provided from an end section opposite side to a sealed fluid (a left end section in the figure) of the fixed section 12 toward an inner side in a radial direction, and a seal lip 14 slidably coming into close contact with a peripheral surface of the shaft 43 is integrally provided from an inner peripheral end section of the lip holding section 13 toward the sealed fluid side (a right side in the figure). Further, the sealing device body 11 is structured, as a part, by attaching (vulcanization bonding) a rubber-like elastic body 18 to an annular member 15, which is made of a rigid material such as a metal or the like by integrally forming of an inward flange section 17 on an end section of a tubular section 16, and the seal lip 14 is integrally formed together with an outer peripheral seal section 19, an end face coating section 20 and a dust lip 21, by the latter rubber-like elastic body 18. A garter spring 22 is fitted to an outer periphery of the seal lip 14.

On the other hand, the oil supply member 31 has a tubular fitting section 32 fitted to an inner peripheral side of the fixed section 12, and a flange-shaped oil supply section 33 is integrally provided from an end section at the sealed fluid side (a right end section in the figure) of the fitting section 32 toward an inner side in a radial direction. Further, the oil supply member 31 is constructed, as a part by a single part, of an annular member 34 which is made of a rigid material such as a metal or the like and integrally formed with an inward flange section 36 on an end section of a tubular section 35.

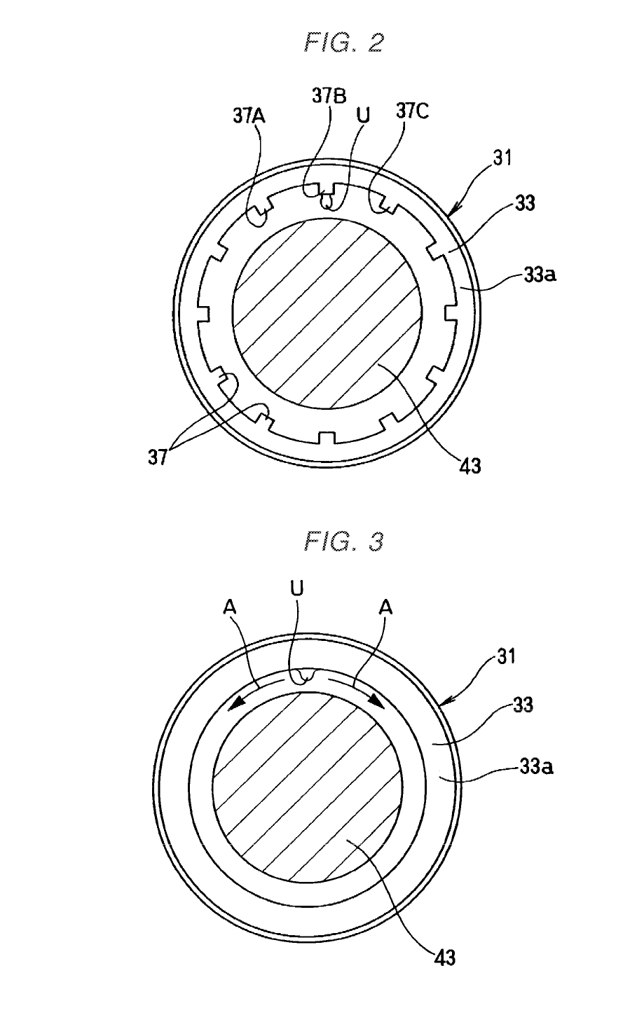

Further, the flange-shaped oil supply section 33 in the oil supply member 31 is arranged at the sealed fluid side from a front end 14a of the seal lip 14, and projecting guide sections 37 for collecting the oil attached to the oil supply section 33 so as to drop onto the shaft are integrally provided on an inner peripheral edge section of the oil supply section 33, as shown in FIG. 2.

The sealing device 1 having the structure mentioned above is structured such as to be installed between the housing 41 and the shaft 43 as shown in FIG. 1 so as to seal a mist-like oil existing in a machine inner side, and has a feature in a point that the following operation and effect can be achieved by the structure mentioned above.

In the sealing device 1 having the structure mentioned above, since the oil supply member 31 is assembled with the sealing device body 11, and the oil supply member 31 is structured such as to collect the oil attached thereto so as to drop onto the shaft, as mentioned above, it is possible to lubricate a sliding section of the seal lip 14 by the dropped oil.

Further, the sealing device body 11 integrally has the tubular fixed section 12 fixed to the inner periphery of the shaft hole 42 of the housing 41, and the seal lip 14 slidably coming into close contact with a peripheral surface of the shaft 43. On the other hand, the oil supply member 31 integrally has the tubular fitting section 32 fitted to the inner peripheral side of the fixed section 12, and the flange-shaped oil supply section 33 provided from the fitting section 32 toward the inner side in the radial direction. Accordingly, since both the elements 11 and 31 are structured such as to be manufactured as separate bodies and be thereafter assembled with each other, it is possible to assemble the oil supply member 31 with the sealing device body 11 in a later stage as occasion demands.

Further, the oil supply member 31 has the flange-shaped oil supply section 33, and the flange-shaped oil supply section 33 is structured such as to attach the mist-like oil to the axial end face 33a and collect it so as to drop onto the shaft as an oil drop U. Accordingly, since the oil supply section 33 is structured such as to be formed in the flange shape and have the comparatively wide axial end face 33a, it is possible to attach a lot of oil so as to drop down.

Further, if the flange-shaped oil supply section 33 is arranged above the seal lip 14, there is fear that the oil is dropped onto the seal lip and is not dropped onto the shaft, so that the oil is not supplied to the sliding section of the seal lip 14. However, in the embodiment mentioned above, since the oil supply section 33 is arranged at the sealed fluid side from the front end 14a of the seal lip 14, it is possible to securely drop the oil onto the shaft.

Further, as shown in a comparative example in FIG. 3, if the flange-shaped oil supply section 33 remains in the annular shape, there is fear that the attached oil flows away in a circumferential direction along the annular axial end face 33a (an arrow A), and does not drop onto the shaft. However, in the embodiment, since the projecting guide sections 37 for collecting the oil attached to the oil supply section 33 so as to drop onto the shaft are provided in the inner peripheral edge section of the oil supply section 33, it is possible to securely drop the oil onto the shaft from the guide section 37.

Accordingly, in cooperation of the above, it is possible to provide the sealing device 1 achieving an excellent lubricating oil supply performance.

In this case, in FIG. 2 mentioned above, a plurality of projecting guide sections 37 are arranged at even intervals over a whole periphery of the inner peripheral edge section of the oil supply section 33 (twelve sections are arranged at even intervals in the figure), however, since only the guide sections 37 arranged above the shaft 43 can drop the oil onto the shaft (the guide sections at three positions shown by reference symbols 37A, 37B and 37C in the figure), the guide sections 37 may be provided at least at the positions above the shaft 43 on the inner peripheral edge section of the oil supply section 33. In this case, if the installation position is limited as mentioned above, a direction (a direction in a circumferential direction) for attaching the oil supply section 33 is limited. In the case of attaching importance to an easiness of an installing work, it is preferable to arrange a plurality of guide sections 37 at even intervals over the whole periphery of the inner peripheral edge section of the oil supply section 33 as mentioned above.

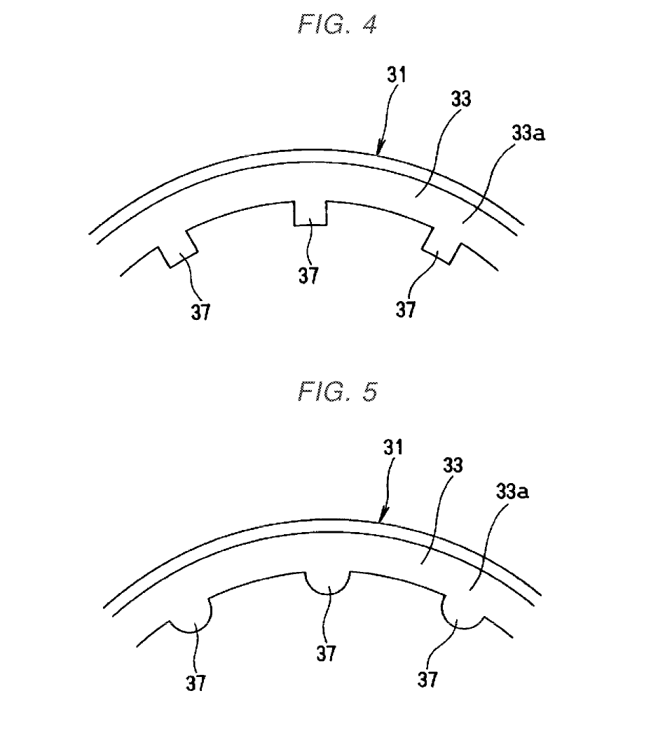

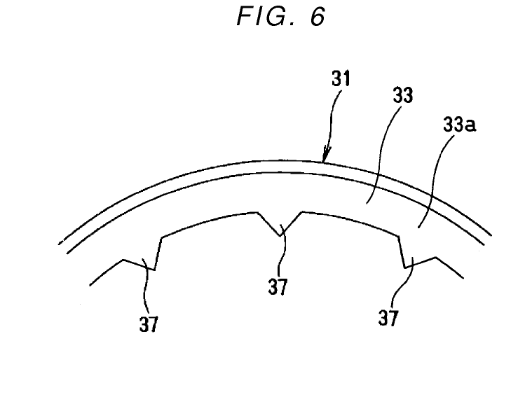

Further, a shape of the guide section 37 is set to a quadrangular shape as shown in FIG. 4, however, is not limited to this particularly, but may be formed, for example, as a round shape (a semicircular shape) as shown in FIG. 5, or a triangular shape as shown in FIG. 6.

### Second Embodiment

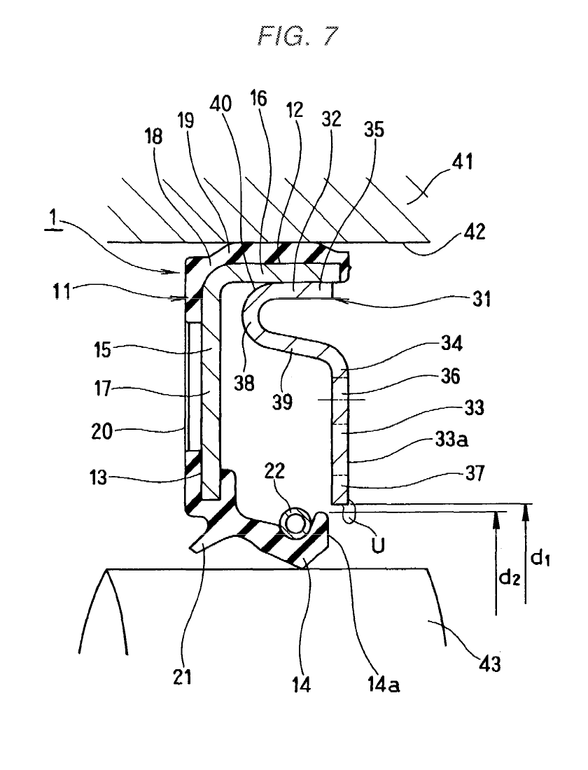

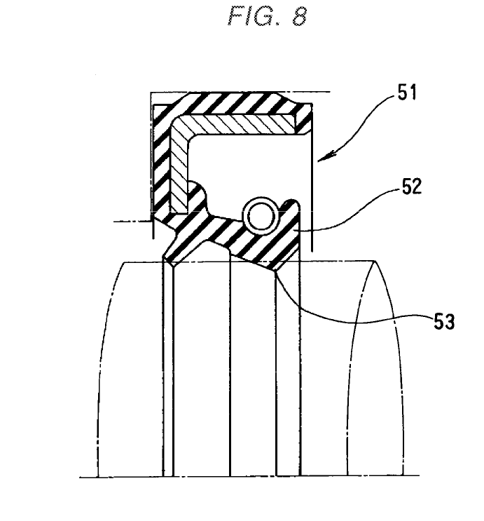

FIG. 7 shows a cross section of a substantial part of a sealing device (also called as an oil seal) 1 in accordance with a second embodiment of the present invention. The sealing device 1 in accordance with the embodiment is structured such as to be installed to an inner periphery of a shaft hole 42 of a housing 41 so as to slidably come into close contact with a peripheral surface of a shaft 43 inserted to the shaft hole 42, and is constructed by a combination of a sealing device body 11 and an oil supply member (also called as an assembling ring, an installing ring or a protecting ring) 31.

The sealing device body 11 has a tubular fixed section 12 fixed to an inner peripheral surface of the shaft hole 42 of the housing 41, flange-shaped lip holding section 13 is integrally provided from an end section at the side opposite to a sealed fluid (a left end section in the figure) of the fixed section 12 toward an inner side in a radial direction, and a seal lip 14 slidably coming into close contact with a peripheral surface of the shaft 43 is integrally provided from an inner peripheral end section of the lip holding section 13 toward the sealed fluid side (a right side in the figure). Further, the sealing device body 11 is structured, as a part, by attaching (vulcanization bonding) a rubber-like elastic body 18 to an annular member 15, which is made of a rigid material such as a metal or the like by integrally forming of an inward flange section 17 on an end section of a tubular section 16, and the seal lip 14 is integrally formed together with an outer peripheral seal section 19, an end face coating section 20 and a dust lip 21, by the latter rubber-like elastic body 18. A garter spring 22 is fitted to an outer periphery of the seal lip 14.

On the other hand, the oil supply member 31 is formed as an annular body integrally having a tubular fitting section 32 fitted to an inner peripheral side of the fixed section 12, a reverse section 38 having a circular arc shaped cross section and integrally formed from an end section at one side (the side opposite to the sealed fluid) in an axial direction of the fitting section 32 toward an inside in a radial direction, an inner peripheral tube section 39 integrally formed from an inner peripheral end section of the reverse section 38 toward the other side (the sealed fluid side) in the axial direction, and a flange-shaped oil supply section 33 integrally formed from the other end section in the axial direction of the inner peripheral tube section 39 toward an inner side in a radial direction. The tubular fitting section 32 and the inner peripheral tube section 39 are arranged concentrically, and a predetermined radial gap is set between both the elements 32 and 39. Further, the oil supply member 31 is constructed, as a part, by a single part of an annular member 34 which is made of a rigid material such as a metal or the like and integrally provided with the tubular fitting section 32, the reverse section 38 having the circular arc shaped cross section, the inner peripheral tube section 39 and the flange-shaped oil supply section 33. The oil supply member 31 to the annular member 34 are formed only by a press work which does not accompany a cutting work. Further, the oil supply member 31 to the annular member 34 has a spring characteristic in a radial direction owing to its cross sectional shape, where a spring section is set to the reverse section 38 having the circular arc shaped cross section.

Further, the flange-shaped oil supply section 33 in the oil supply member 31 is arranged at the sealed fluid side from a front end 14a of the seal lip 14, and a projecting guide sections 37 for collecting the oil attached to the oil supply section 33 so as to drop onto the shaft are integrally provided on an inner peripheral edge section of the oil supply section 33.

The sealing device 1 having the structure mentioned above is structured such as to be installed between the housing 41 and the shaft 43 so as to seal a mist-like oil existing in a machine inner side, and has a feature in a point that the following operation and effect can be achieved by the structure mentioned above, in addition to the achievement of the same operation and effect of the first embodiment mentioned above.

Since the oil supply member 31 integrally has the tubular fitting section 32, the reverse section 38 having the circular arc shaped cross section, the inner peripheral tube section 39 and the flange-shaped oil supply section 33 as mentioned above, and the oil is attached to the inner peripheral surface of the fitting section 32, the inner surface of the reverse section 38 and the outer peripheral surface of the inner peripheral tube section 39, in addition to the surface 33a of the oil supply section 33, the oil attaching area is further enlarged. Accordingly, it is possible to collect a lot of oil, and supply it to the lip slide section.

Further, the oil supply member 31 integrally having the tubular fitting section 32, the reverse section 38 having the circular arc shaped cross section, the inner peripheral tube section 39 and the flange-shaped oil supply section 33 is fitted to the inner peripheral side of the fixed section 12 from the reverse section 38 at a time of being fitted to the sealing device body 11. However, the reverse section 38 is formed to have the circular arc shaped cross section and has a chamfer section 40 which makes fitting easy in its outer surface, and the chamfer section 40 is set only by a press work without a cutting work of the oil supply member 31. Accordingly, it is possible to form the oil supply member 31 having the chamfer section 40 for making fitting to the sealing device body 11 easy only by the press work which does not need the cutting work, whereby it becomes easy to manufacture the device. In this case, as a comparative example relating to this matter, the oil supply member 31 in accordance with the first embodiment can be indicated, where it is necessary to form a chamfer section 32a at a front end outer periphery of the tubular fitting section 32 in the oil supply member 31 in accordance with the cutting work, as shown in FIG. 1, and the corresponding work step can be omitted by the present embodiment.

Further, in the second embodiment, it is preferable that an inner diameter (an inner peripheral diameter) d₁ of the oil supply member 31 is set comparatively large, in particular, is set larger than an outer diameter d₂ of the seal lip front end 14a. This is because of the following reasons.

If the inner diameter d₁ of the oil supply member 31 is set smaller than the above, an amount of the oil directly supplied to the lip 14 is reduced, and there may occur a problem of the heat deterioration caused by the poor lubrication and a reduction of the seal service life caused by the sliding abrasion or the like. Further, the oil coming around the inner side of the oil supply member 31 is easily held by making the inner diameter d₁ of the oil supply member 31 closer to the outer diameter of the shaft 43. However, since the held oil is hardly discharged on the other hand, and the deteriorated oil is reserved, and this structure is not preferable in a point of the seal service life. It is preferable to set a difference between the inner diameter d₁ of the oil supply member 31 and the outer diameter d₂ of the seal lip front end 14a larger than about 1 to 2 mm in an actual size. In this case, the matter relating to the diameter is applied to the sealing device 1 in accordance with the first embodiment in addition to the second embodiment.

Further, in the second embodiment, the inner peripheral tube section 39 in the oil supply member 31 is formed in a taper shape (a conical surface shape), that is, is formed in a taper shape directed such that a diameter is reduced little by little from the reverse section 38 toward the oil supply section 33, as illustrated. Accordingly, it is set such that the oil tends to flow from the outer peripheral surface of the inner peripheral tube section 39 toward the front face 33a of the oil supply section 33. Further, since a mold releasing resistance from the press mold is reduced at a time of press forming of the oil supply member 31 to the annular member 34, it is possible to prevent a deformation at a time of releasing the product from the mold, and it is possible to easily collect the oil attached to the inner peripheral surface of the inner peripheral tube section 39.

What is claimed is:

1. A sealing device installed to an inner periphery of a shaft hole of a housing and slidably coming into close contact with a peripheral surface of a shaft inserted to said shaft hole, the sealing device comprising:
a sealing device body integrally having a tubular fixed section fixed to the inner periphery of the shaft hole of said housing, and a seal lip slidably coming into close contact with the peripheral surface of said shaft; and
an oil supply member integrally having a tubular fitting section fitted to an inner peripheral side of said fixed section, and a flange-shaped oil supply section provided toward an inner side in a radial direction from said fitting section,
wherein said oil supply section is arranged at a sealed fluid side from a front end of said seal lip, and projecting guide sections for collecting an oil attached to said oil supply section so as to drop onto the shaft are provided at least at positions above the shaft on an inner peripheral edge section of said oil supply section.

2. A sealing device as claimed in claim 1, wherein the oil supply member integrally has a tubular fitting section fitted to the inner peripheral side of the fixed section, a reverse section having a circular arc shaped cross section and integrally formed toward an inner side in a radial direction from one end section in an axial direction of said fitting section, an inner peripheral tube section integrally formed on said reverse section, and a flange-shaped oil supply section integrally formed toward the inner side in the radial direction from the other end section in the axial direction of said inner peripheral tube section, and projecting guide sections are provided on an inner peripheral edge section of said oil supply section.
